(19) United States
(12) Patent Application Publication
(10) Pub. No.: US 2008/0228953 A1
(43) Pub. Date: Sep. 18, 2008

(54) Signal playback system with a dynamic wiring aid and method thereof

(75) Inventor: Hung-Yuan Li, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/717,767

(22) Filed: Mar. 14, 2007

(51) Int. Cl. G06F 3/00

(52) U.S. Cl. 710/16

(57) ABSTRACT

A signal playback system includes a plurality of connection interfaces installed for connecting at least one external device, an input interface for selecting one of the plurality of connection interfaces to be connected to the external device, a display device for displaying connecting information of the plurality of connection interfaces, and a logic unit for controlling the display device to display the corresponding connecting information according to the connection interface selected by the input interface.

### BACKGROUND OF THE INVENTION

1. Field of the Invention

The present invention relates to a signal playback system, and more specifically, to a signal playback system with a dynamic wiring aid and method thereof.

2. Description of the Prior Art

A variety of signal devices have been developed with the improvement of media playback techniques. With the media playback techniques changing with every passing day, various signal transmission specifications have also come out with the tide of fashion. However, such a variety of signal transmission specifications make a user confused. For example, a user usually has no idea of which is the right connection interface when trying to couple a TV with a signal playback device (VCD player, DVD player, DVR, etc.) for the first time. That is because there are so many connection interfaces (CVBS, S-video, YPbPr, etc.) set up on the devices that the user has to spend much time reading the manual or asking an expert for advice as to how to plug a terminal in a right connection interface. If the user happens to lose a manual, it is more difficult for the user to make the correct choice. It is really inconvenient for the use of signal playback devices.

### SUMMARY OF THE INVENTION

The present invention provides a signal playback system comprising a plurality of connection interfaces for coupling at least one external device, an input interface for selecting a connection interface to be coupled to the external device from the plurality of connection interfaces, a display device for displaying connection statuses of the plurality of connection interfaces, and a logic unit coupled to the input interface and the display device for controlling the display device to display a connection status of the connection interface selected by the input interface.

The present invention further provides a method for indicating connection statuses of selected connection interfaces, the method comprising selecting at least one connection interface of a plurality of connection interfaces of a signal playback device, and indicating a connection status of the selected connection interface.

The present invention further provides a method for indicating connection statuses of selected connection interfaces, the method comprising displaying a plurality of connection interface options on a display device of a signal playback device, and when a connection interface option of the plurality of connection interface options is selected, displaying a connection status of a connection interface corresponding to the selected connection interface option. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view of a signal playback system according to the embodiment of the present invention.

FIG. 2 is a perspective view of a signal recorder according to the embodiment of the present invention.

FIG. 3 is a functional block diagram of the signal playback system in FIG. 2.

FIG. 4 shows a CVBS connection interface and the connection switch in FIG. 3.

FIG. 5 is a flowchart of a connection status of the signal playback system in FIG. 1.

FIG. 6 is a diagram of options displayed on the display device in FIG. 3.

FIG. 7 is a diagram of connection statuses displayed on the display device in FIG. 3.

### DETAILED DESCRIPTION

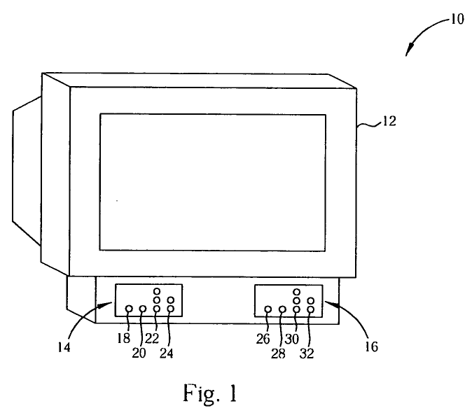

Please refer to FIG. 1. FIG. 1 is a perspective view of a signal playback system 10 according to the embodiment of the present invention. The signal playback system 10 comprises a case 12, an output connection interface 14 installed on the case 12, and an input connection interface 16 installed on the case 12. The output connection interface 14 comprises an S-video connection interface 18 for outputting video signals conforming to Y/C signal specifications to an external device, a CVBS connection interface 20 for outputting video signals conforming to CVBS signal specifications to an external device, a YPbPr connection interface 22 for outputting video signals conforming to YPbPr signal specifications to an external device, and an audio connection interface 24 for outputting audio signals to an external device. Similarly, the input connection interface 16 comprises an S-video connection interface 26 for receiving video signals conforming to Y/C signal specifications from an external device, a CVBS connection interface 28 for receiving video signals conforming to CVBS signal specifications from an external device, a YPbPr connection interface 30 for receiving video signals conforming to YPbPr signal specifications from an external device, and an audio connection interface 32 for receiving audio signals from an external device.

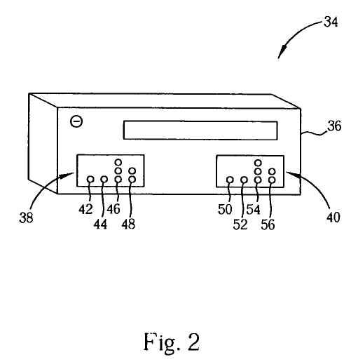

Please refer to FIG. 1 and FIG. 2. FIG. 2 is a perspective view of a signal recorder 34 according to the embodiment of the present invention. The signal recorder 34 comprises a case 36, an output connection interface 38 installed on the case 36, and an input connection interface 40 installed on the case 36. The output connection interface 38 comprises an S-video connection interface 42, a CVBS connection interface 44, a YPbPr connection interface 46, and an audio connection interface 48. The S-video connection interface 42 may be coupled to the S-video connection interface 26 for outputting video signals conforming to Y/C signal specifications to the signal playback system 10. The CVBS connection interface 44 may be coupled to the CVBS connection interface 28 for outputting video signals conforming to CVBS signal specifications to the signal playback system 10. The YPbPr connection interface 46 may be coupled to the YPbPr connection interface 30 for outputting video signals conforming to YPbPr signal specifications to the signal playback system 10. The audio connection interface 48 may be coupled to the audio connection interface 32 for outputting audio signals to the signal playback system 10.

Similarly, the input connection interface 40 comprises an S-video connection interface 50, a CVBS connection interface 52, a YPbPr connection interface 54, and an audio connection interface 56. The S-video connection interface 50 may be coupled to the S-video connection interface 18 for receiving video signals conforming to Y/C signal specifications from the signal playback system 10. The CVBS connection interface 52 may be coupled to the CVBS connection interface 20 for receiving video signals conforming to CVBS signal specifications from the signal playback system 110. The YPbPr connection interface 54 may be coupled to the YPbPr connection interface 22 for receiving video signals conforming to YPbPr signal specifications from the signal playback system 10. The audio connection interface 56 may be coupled to the audio connection interface 24 for receiving audio signals from the signal playback system 10.

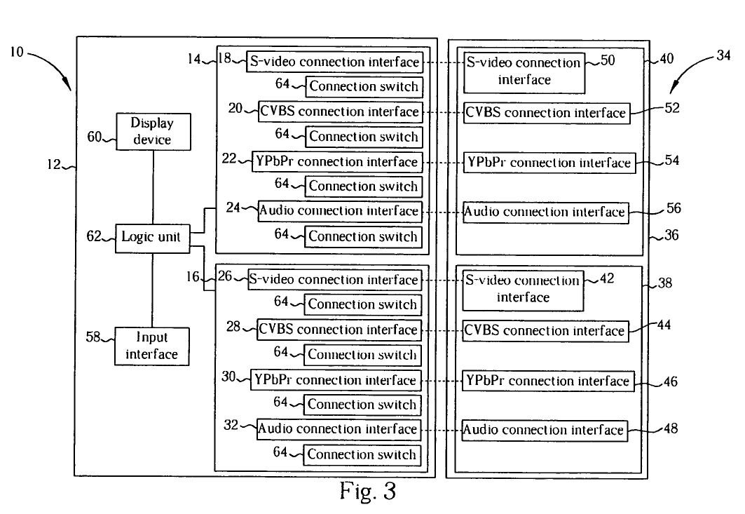

Please refer to FIG. 1, FIG. 2, and FIG. 3. FIG. 3 is a functional block diagram of the signal playback system 10 according to the embodiment of the present invention. The signal playback system 10 comprises an input interface 58, a display device 60, and a logic unit 62. The input connection interface 58 can be a remote control or a plurality of buttons set up on the case 12 for selecting a desired connection interface by On Screen Display (OSD). The display device 60 can be a TV screen for displaying a connection status of a selected connection interface. The logic unit 62 can be hardware, software, firmware, and so on for indicating on the display device 60 the connection status of the selected connection interface.

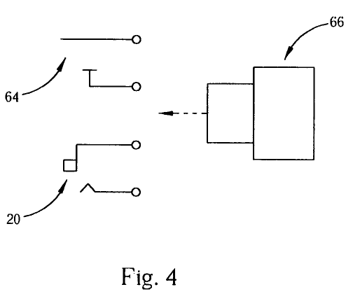

The signal playback system 10 comprises a plurality of connection switches 64 coupled to the logic unit 62. A connection switch 64 of the plurality of connection switches 64 is used to indicate to the logic unit 62 whether the connection interface is coupled to an external device. Please refer to FIG. 4 for example. FIG. 4 shows the CVBS connection interface 20 and the connection switch 64. When the CVBS connection interface 20 is not coupled to the connection switch 64, a connection status between the CVBS connection interface 20 and the connection switch 64 is in the off state. When a terminal 66 is coupled between the CVBS connection interface 20 and the connection switch 64, an upper part of the CVBS connection 20 is pressed to contact a lower part of the CVBS connection 20 by the terminal 66. At the same time, the lower part of the connection switch 64 is also pressed to contact the upper part by the terminal 66. Then the connection status between the CVBS connection interface 20 and the connection switch 64 is in the on state at this moment. Therefore, a signal of whether the CVBS connection 20 is coupled to the terminal 66 is available according to the connection status between the CVBS connection interface 20 and the connection switch 64.

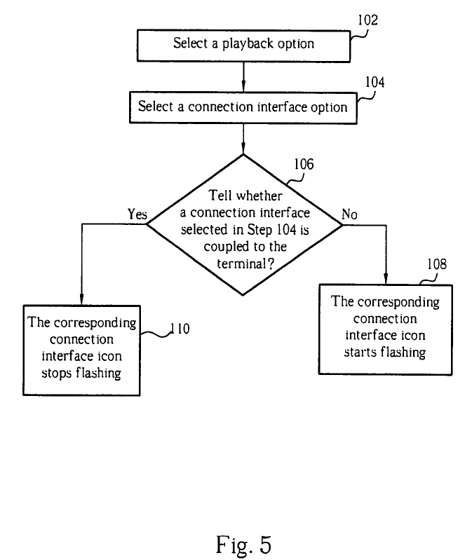

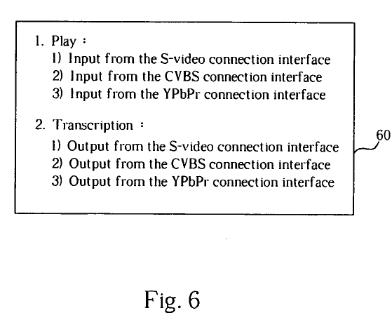

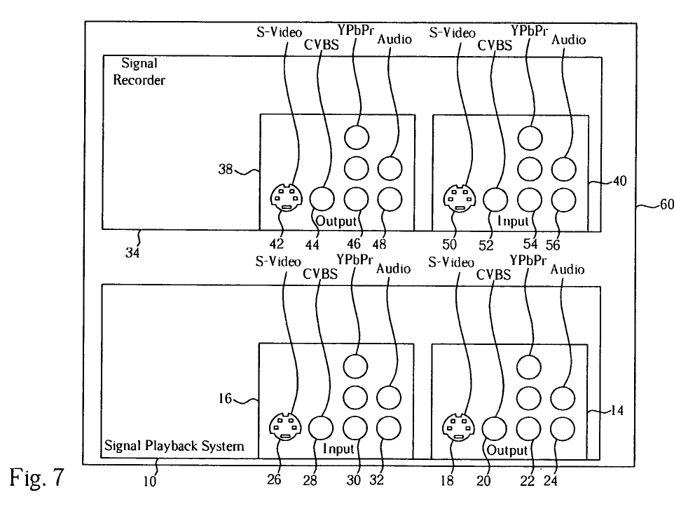

Please refer to FIG. 5, FIG. 6, and FIG. 7. FIG. 5 is a flowchart of a connection status of the signal playback system 10 according to the embodiment of the present invention. FIG. 6 is a diagram of options displayed on the display device 60. FIG. 7 is a diagram of connection statuses displayed on the display device 60. The method includes the following steps.
Step 102: use the input interface 58 to select a playback option (‘Play’ or ‘Transcription’) by On Screen Display (OSD).
Step 104: use the input interface 58 to select a connection interface option by OSD.
Step 106: tell whether a connection interface selected in Step 104 is coupled to the terminal. If so, go to Step 110. If not, go to step 108.
Step 108: when the connection interface selected in Step 104 is not coupled to the terminal, a corresponding connection interface icon starts flashing.
Step 110: when the connection interface selected in Step 104 is coupled to the terminal, the corresponding connection interface icon stops flashing.

More detailed description for the steps listed above is provided as follows. First, a user can see an image as shown in FIG. 6. Then the user can use the input interface 58 to select a playback option and a connection interface option by OSD. After the user selects the connection interface, the image as shown in FIG. 6 will switch to an image as shown in FIG. 7. For example, when the user selects ‘Play’ and ‘Input from the S-video connection interface’, the connection switch 64 in the S-video connection interface 26 will indicate to the logic unit 62 whether the S-video connection interface 26 is coupled to a terminal.

When the S-video connection interface 26 is not coupled to the terminal, the logic unit 62 will indicate an S-video connection interface 26 icon and an S-video connection interface 42 icon displayed on the display device 60 starts flashing to inform the user that the terminal is not connected. When the user finishes plugging the terminal in, the S-video connection interface 26 icon and the S-video connection interface 42 icon displayed on the display device 60 will stop flashing to inform the user of a proper connection.

Furthermore, the signal playback system 10 receives audio signals from the signal recorder 34. Similarly, principles of the audio connection interface 32 and the audio connection interface 48 are the same as what is mentioned above. A way to inform the user of plugging the terminal in is not limited to only flashing icons displayed on the display device 60. For example, not only displaying other images but also producing various colors or sound signals can be alternatively used. A purpose of what is mentioned above is to make sure that the user can plug the terminal in a right connection interface. The principles of other connection interfaces are as the same as the example mentioned above.

In the same manner, when the connection interface is not coupled to the terminal, the logic unit 62 can also cause the connection interface icon displayed on the display device 60 to stop flashing and when the connection interface is coupled to the terminal, the logic unit 62 causes the connection interface icon displayed on the display device 60 to start flashing.

The signal playback system 10 of the present invention indicates to the user to plug the terminal in the right connection interface step by step, so the user can complete the whole plugging job easily and correctly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A signal playback system comprising:
a plurality of connection interfaces for coupling at least one external device;
an input interface for selecting a connection interface to be coupled to the external device from the plurality of connection interfaces;
a display device for displaying connection statuses of the plurality of connection interfaces; and
a logic unit coupled to the input interface and the display device for controlling the display device to display a connection status of the connection interface selected by the input interface.

2. The signal playback system of claim 1, wherein the connection interface is a CVBS connection port for inputting or outputting video signals conforming to CVBS specifications.

3. The signal playback system of claim 1, wherein the connection interface is an S-video connection port for inputting or outputting video signals conforming to Y/C signal specifications.

4. The signal playback system of claim 1, wherein the connection interface is a YPbPr connection port for inputting or outputting video signals conforming to YPbPr signal specifications.

5. The signal playback system of claim 1, wherein the connection interface is an audio connection port for inputting or outputting audio signals.

6. The signal playback system of claim 1, wherein the input interface is On Screen Display (OSD).

7. The signal playback system of claim 1 further comprising a connection switch coupled to the logic unit for indicating the logic unit whether the connection interface is coupled to an external device.

8. A method for indicating connection statuses of selected connection interfaces comprising:
selecting at least one connection interface of a plurality of connection interfaces of a signal playback device; and
indicating a connection status of the selected connection interface.

9. The method of claim 8 further comprising providing a connection interface for inputting signals to the signal playback device.

10. The method of claim 8 further comprising providing a connection interface for outputting signals to an external device from the signal playback device.

11. The method of claim 8, wherein indicating the connection status of the selected connection interface comprises flashing a figure corresponding to the selected connection interface when the selected connection interface is not coupled to an external device.

12. The method of claim 8, wherein indicating the connection status of the selected connection interface comprises flashing a figure corresponding to the selected connection interface when the selected connection interface is coupled to an external device.

13. A method for indicating connection statuses of selected connection interfaces comprising:
displaying a plurality of connection interface options on a display device of a signal playback device; and
when a connection interface option of the plurality of connection interface options is selected, displaying a connection status of a connection interface corresponding to the selected connection interface option.

14. The method of claim 13, wherein displaying the plurality of connection interface options comprises displaying connection interface options of connection interfaces utilized for inputting signals to the signal playback device.

15. The method of claim 13, wherein displaying the plurality of connection interface options comprises displaying connection interface options of connection interfaces utilized for outputting signals from the signal playback device.

16. The method of claim 13, wherein indicating the connection status of the connection interface corresponding to the selected connection interface option comprises flashing a figure corresponding to the connection interface when the connection interface is not coupled to an external device.

17. The method of claim 13, wherein indicating the connection status of the connection interface corresponding to the selected connection interface option comprises flashing a figure corresponding to the connection interface when the connection interface is coupled to an external device.
